(19) United States
(12) Patent Application Publication
(10) Pub. No.: US 2013/0087352 A1
(43) Pub. Date: Apr. 11, 2013

(54) PORTABLE ICE BREAKING TOOL WITH TWO RECIPROCATING BLADES

(71) Applicants: Fred Rudy, Brooklyn, NY (US); Andrew Grove, Pittsburgh, PA (US)

(72) Inventors: Fred Rudy, Brooklyn, NY (US); Andrew Grove, Pittsburgh, PA (US)

(73) Assignees: Fred Rudy; ANDREW GROVE, PITTSBURGH, PA (US)

(21) Appl. No.: 13/267,566

(22) Filed: Oct. 6, 2011

(51) Int. Cl. A01B 1/10; F25C 5/04

(52) U.S. Cl. 172/48; 241/169

(57) ABSTRACT

The present invention provides a portable ice chopper assembly having dual reciprocating blades for chopping ice. A gear box assembly is connected to the rotating motor assembly for converting the rotating movement of the motor assembly into reciprocating movement of the dual chopping blades. Dual reciprocating plungers are connected to and driven by the gear box assembly for driving the plungers in a reciprocating up and down linear movement, wherein the plungers each have respective horizontal actuating bars. The cutting blades move up and down in a linear reciprocating movement, with the two cutting blades moving up and down in an alternating manner to chop the ice.

### FIELD OF THE INVENTION

The present invention relates to a novel portable and reciprocating ice breaking tool or ice chopper having dual reciprocating ice chopping blades or ice breaking blades in order to more efficiently chop and remove ice from surfaces.

### BACKGROUND OF THE INVENTION

Although ice choppers or ice breakers have been used for many years, they have drawbacks which make them unsatisfactory for easy and efficient use.

For example, U.S. Pat. No. 4,305,470 shows in FIG. 3 a rotating shaft 12 which drives a cutting blade 20 and 44 to reciprocate up and down to break or cut the ground. U.S. Pat. No. 5,697,453 operates in a similar manner, as shown in FIG. 3. Rotating shaft 36 drives cutting shaft 54 to reciprocate up and down, and to cut.

### OBJECTS OF THE INVENTION

It is an object of the present invention to provide an ice chopper having two reciprocating blades in order to provide more efficient ice chopping in an easy and fast manner.

It is another object of the present invention to provide a unique gear box assembly to provide quick and efficient reciprocating action for the dual-acting ice blades.

It is another object of the present invention to provide a portable ice chopper which has a battery pack and is cordless.

It is another object of the present invention to provide ergonomic handles on the ice chopper tool of the present invention so that it is easy to hold and control the reciprocating blade action, and a tool that is lightweight and easy to use.

### SUMMARY OF THE INVENTION

The present invention provides a portable ice chopper or ice breaking assembly having dual reciprocating blades for chopping or breaking ice. A lightweight housing assembly having an internal compartment and ergonomic handles is provided for controlling and operating the ice chopper assembly. An AC/DC rotating motor assembly is mounted in the internal compartment. A gear box assembly is connected to the rotating motor assembly for converting the rotating movement of the motor assembly into reciprocating movement of the dual chopping or cutting blades. Dual reciprocating plungers are connected to and driven by the gear box assembly for driving the plungers in a reciprocating up and down linear movement, wherein the plungers each have respective horizontal actuating bars. A crank assembly having eccentric bosses mounted on both sides of the crank assembly is provided for engaging and driving the horizontal bars on the plungers, so that the dual plungers are moved in alternating up and down movements. Dual chuck assemblies are connected to the dual plungers to drive the dual reciprocating ice cutting blades so that the cutting blades move up and down in a linear reciprocating movement, with the two cutting blades moving up and down in an alternating manner to chop the ice.

### BRIEF DESCRIPTION OF THE DRAWINGS

FIG. 1 is a perspective view of the portable ice chopper assembly having dual reciprocating blades for chopping ice;

FIG. 2 shows motor assembly 60 and the gear box assembly 34;

FIG. 3 is a detailed view of the gear box assembly 54 and the crank assembly 5;

FIG. 4 is a detailed view of the ergonomic handles having a finger switch 13 connected to the variable speed control 15 and a standard AC male plug 14;

FIG. 5 is a detailed view of the dual reciprocating plungers 6 connected to the dual reciprocating ice blades 28;

FIG. 6 is a detailed view of the crank assembly 5 having eccentric bosses 5b and 5c that ride on the horizontal actuating bars 6a and 6b on the two plungers 6 to drive the plungers 6 up and down;

FIG. 7 is a detailed view of the chuck case 20 and the chuck throat 19 for connecting to the two reciprocating plungers 6;

FIG. 8 is a detailed view of the printed circuit board 24;

FIGS. 9, 10, and 11 show specific tool attachments for breaking up ice; and

FIGS. 12 to 18 show specific tool attachments for breaking up soil, removing weeds, aerating, planting bulbs, an edging attachment, a pitch tool, and a shovel attachment.

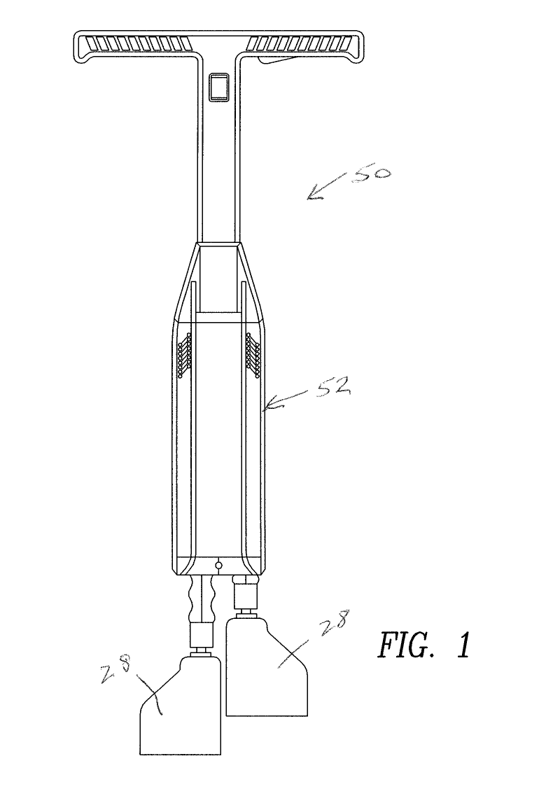

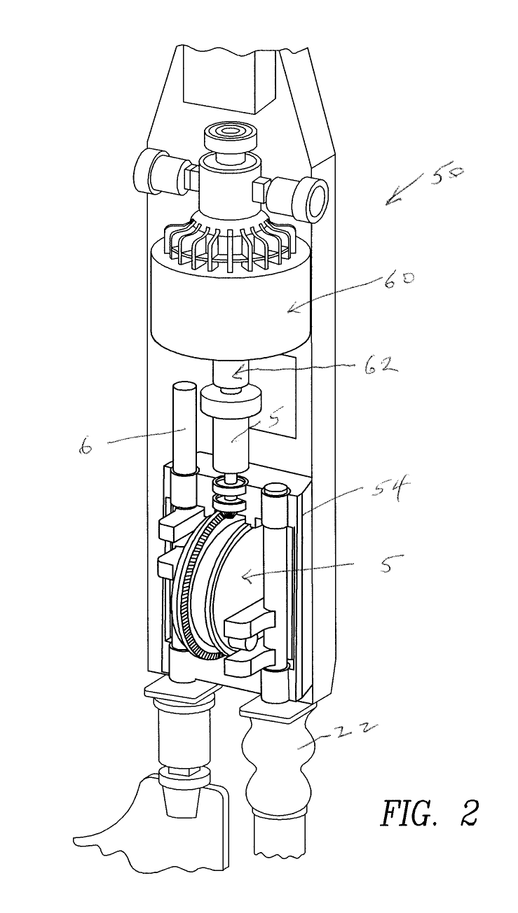

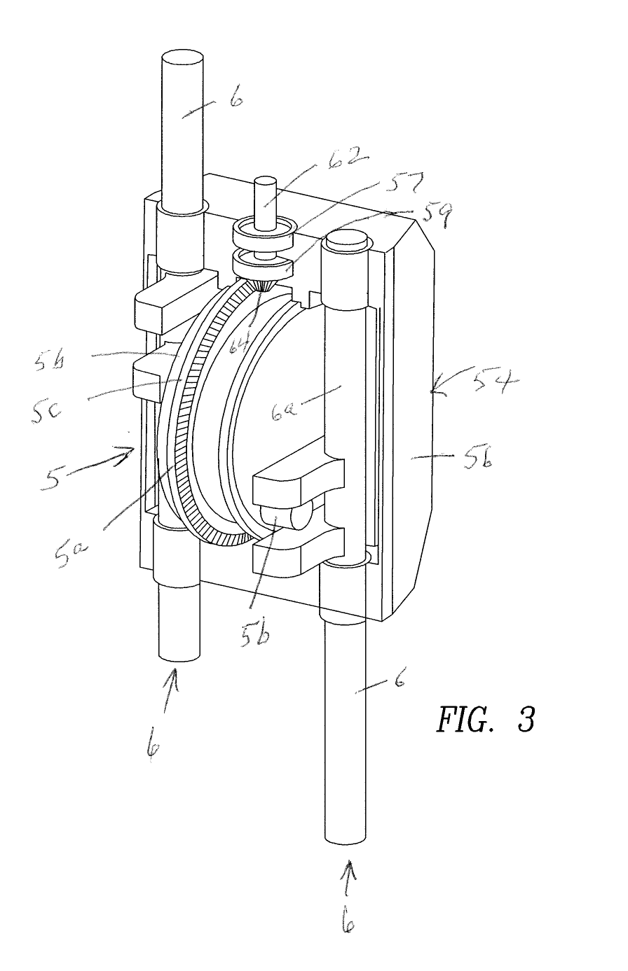

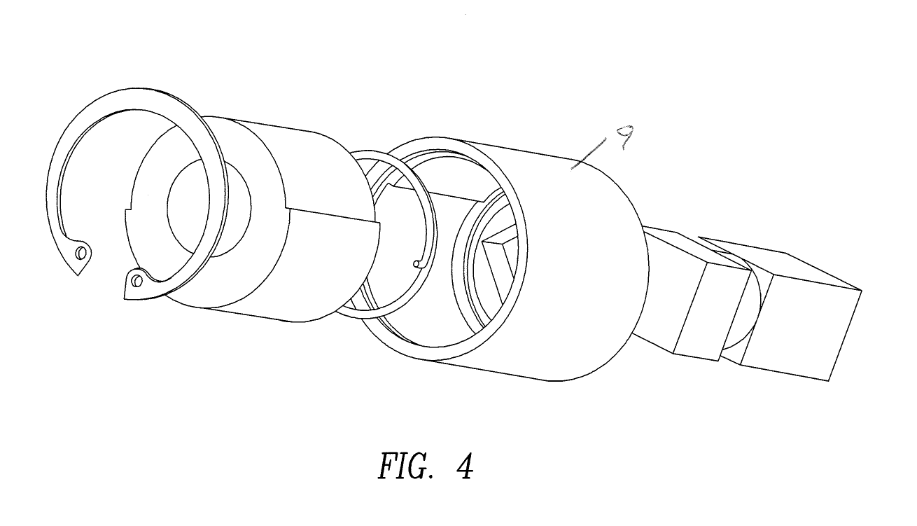

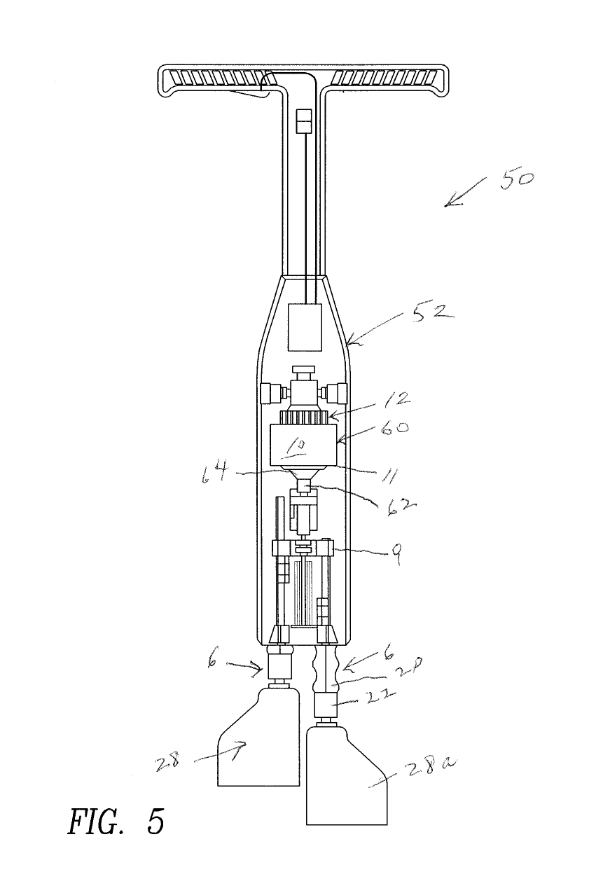

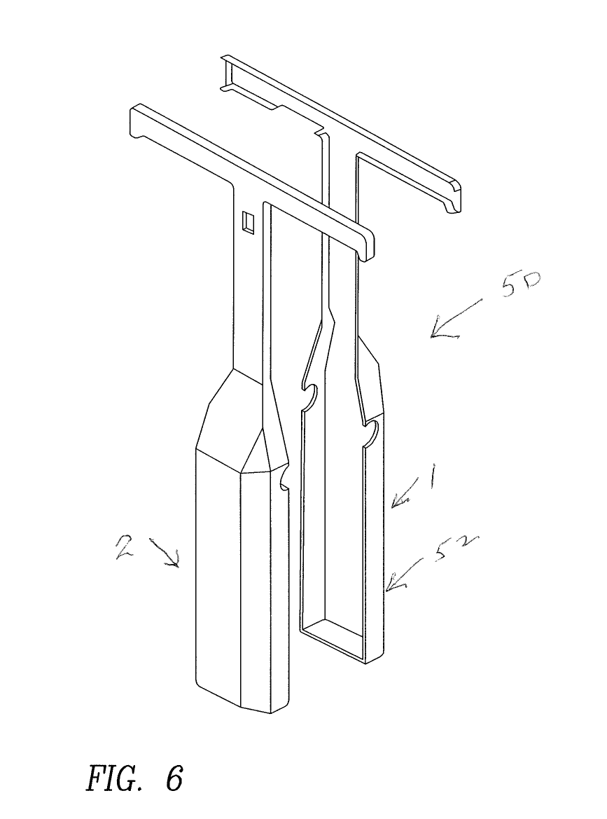

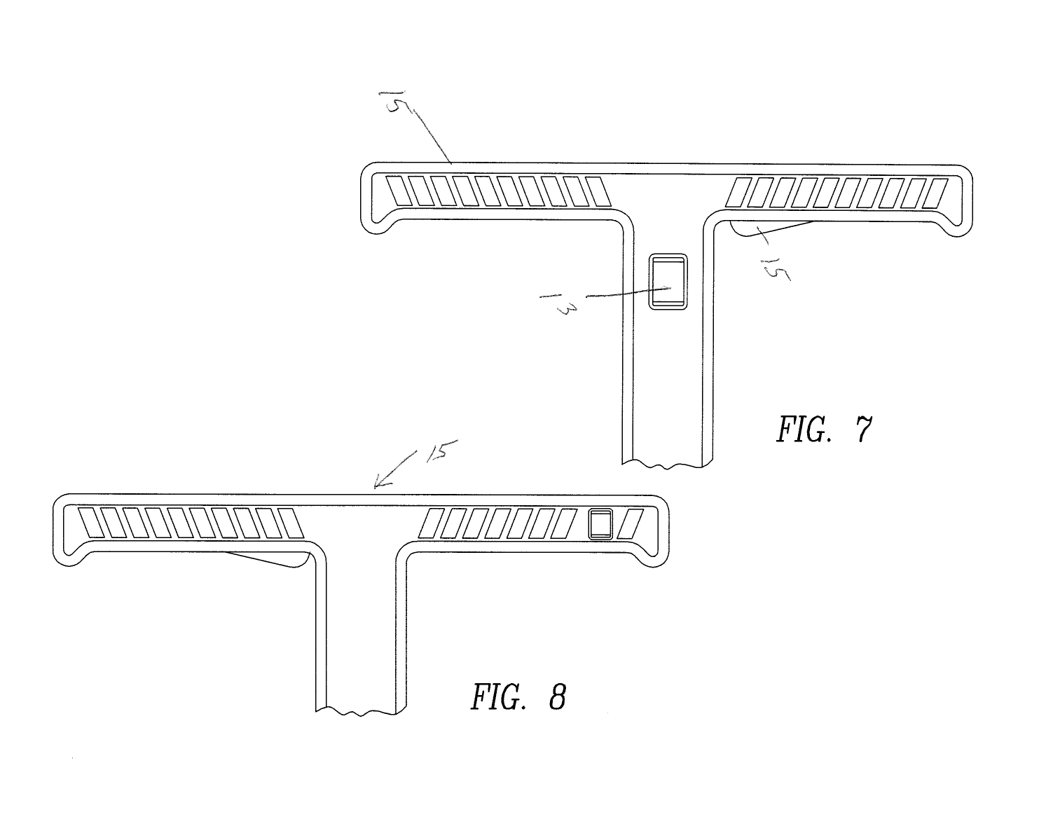

### DETAILED DESCRIPTION OF THE PREFERRED EMBODIMENT

As shown in the drawings, the ice chopping tool 50 has two plastic clam shell halves 1 and 2 to form the outer housing 52, and both halves are mechanically attached. The housing 52 has an internal compartment and is formed to house and support the internal working mechanisms of the ice chopping tool 50. Handle segments 1a and 2a are connected to the housing 52 and may have over molded soft grip areas for comfort and support.

The motor assembly 60 has a stator 10 and a magnetic field portion 11, which is housed and supported by clam shells 1 and 2. The motor brush assembly 12 is connected to stator 10, and it is housed and supported by the clam shells 1 or 2. Motor assembly 60 has a rotating output shaft 62 having a bevel gear 64 on its lower end for driving crank assembly 5 in gear box assembly 54.

The gear box assembly 54 has front and back outer housing members 56 and 58 and are mechanically fastened together after all of the internal gear box components have been installed. Internal features of the housing members 56 and 58 support the bearings 57 and 59 from the crank and plungers, as explained below. Gear box assembly 54 is formed of rigid plastic or cast metal.

The crank assembly 5 converts the rotary motion provided by the motor assembly 60 to the reciprocating linear motion for driving the two plungers 6 and the two reciprocating chopper blades 28. There is a bevel gear tooth formation 5a on crank assembly 5 that engages with the bevel spur gear 64 driven by the motor shaft 62 to transmit the rotary motion. The sides of the crank 5 have an eccentric boss 5b and 5c that ride along the horizontal actuating bars 6a and 6b formed on the plungers 6 for transmitting force to drive the plungers 6 in an up and down reciprocating linear motion. The two bosses 5b and 5c are 180 degrees apart from the main rotating axis of the crank assembly 5, which is formed of high grade steel.

The pair of plungers 6 have horizontal actuating bars 6a and 6b on the plungers, which ride on the outside of the eccentric bosses 5b and 5c on the crank assembly 5. Supported by bearings above and below the crank assembly 5, the plungers 6 are mechanically connected to the tool chuck assemblies 22 at the lower ends of the plungers 6 which are formed of high grade steel.

A bushing 7 or roller type bearing has a large inner diameter relative to its width. The material is steel composite, bronze, or plastic. The bevel gear 64 drives the crank assembly 5.

A plain bearing 9 guides the plunger shaft 8 on the lower end of plungers 6 above and below crank 5 through the gear box assembly 52. The bearings are housed in the gear box 54 at the top and bottom of the two plungers 6. The materials are bronze or plastic.

A finger switch 13 is mounted and supported by the handle portion 15 of the front or back clam shell housings 1 or 2. The switch 13 is an electro-mechanical assembly and functions as the on/off switch for the chopping tool, as well as providing variable motor speed based on the amount of switch depression, which is controlled by the operator.

A 24 volt Lithium Ion battery pack 17 is provided. The battery is housed and supported in an easily removable fashion to the back body segment 2 as shown. The battery provides the operator with a cordless power option for the tool. The printed circuit board 24 controls the electronics and the power supply.

A standard AC male plug 14 is mounted and supported by the handle portion 1a and 2a. Plug end 14 allows for a standard extension cord to be plugged into the tool handle for providing AC operational power to it.

A rotary variable speed control unit 15 works in conjunction with the finger switch 13 to allow the operator a wide range of motor speed control.

There are a pair of LED lights 16. One light is mounted and supported in the front body segment 1, and the other light is mounted in the back body segment 2. The lights 16 are switched on and off in conjunction with the depressing of the finger switch item 13 and the lights focus on the tool 27 mounted in the chuck assembly 20.

The transformer 18 supplies power to the motor assembly 60. This unit controls the combination of AC and DC power options for the tool. Transformer 18 is mounted and supported by the back half of the body segment 2 as shown.

A chuck throat 19 is connected to each of the plungers 6. The chuck throats 19 are mechanically connected to the end of the plunger shaft 6 and accept the square shaft ends of the selected tool 27 to be used in the chopper. The outside face is a stepped cylinder that works in conjunction with the chuck case 20 to provide a quick change tool retainer.

The chuck case 20 covers each chuck throat 19. The chuck case 20 works in conjunction with the chuck throat 19 to provide a quick change tool retainer. The chuck case is rotated 45 degrees about its central axis against the force of locking spring 21 to align the square opening on chuck case 20 with the square opening in the chuck throat 19. When the tool is inserted, the spring rotates the chuck case back 45 degrees. The locking spring 21 provides the force to keep the chuck case 20 in position to capture the inserted tool.

Shock absorbers 22 are placed axially in between the top of the inserted tool shaft at the bottom end of each plunger shaft 6. The material of the shock absorbers has a high durometer impact dampening quality. The internal retaining ring 23 is used to secure the internal components of the chuck assembly 20. Bearing 25 is used to support the bevel gear shaft 62, 64 inside the gear box assembly 54.

A protective boot 26 is attached to the base of the chopper body and to the chuck assembly 20. The boot 26 protects the shaft 8 of the plunger 6 from receiving foreign debris.

### Attachments for Removing Ice

The tool component 27 is mounted on the top of each attachment, such as the chopper blade for ice or cutting blade 28 for ice. The square shaft end of tool 27 is inserted into the chuck and performs its function using the reciprocating action of the plunger shafts 8.

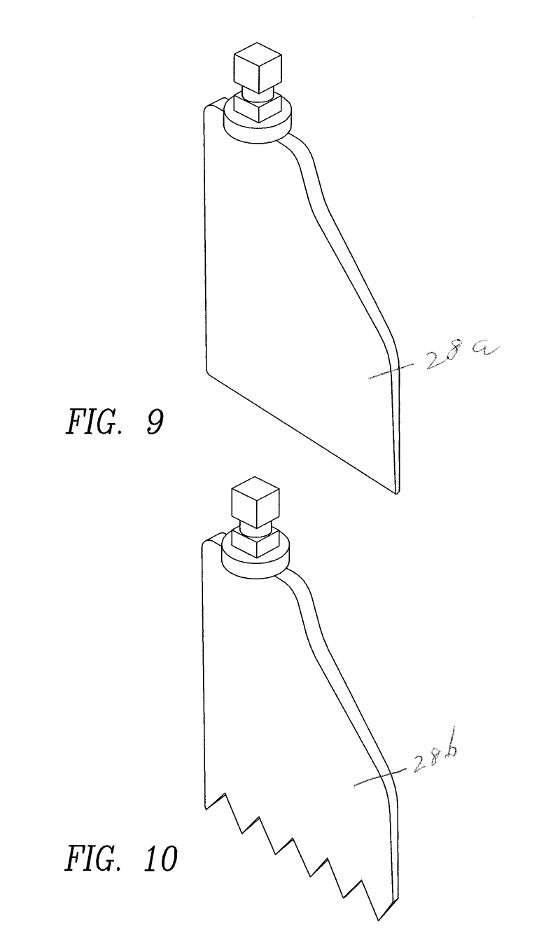

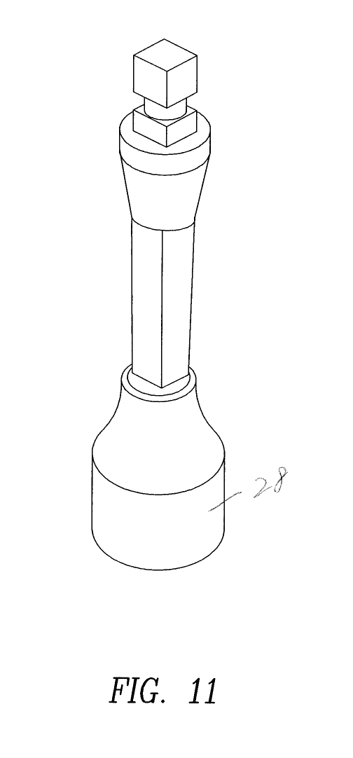

For ice removing functions, there are a variety of tool components allowing the ice attachments 50 to perform a number of specialized tasks, including breaking up ice with an ice blade, a toothed ice blade, or a hammer. These specific tools and attachments are shown in FIGS. 9 to 11. More specifically, FIG. 9 shows the tool attachment for breaking up ice; FIG. 10 shows the toothed ice attachment for chopping ice; and FIG. 11 shows the tool attachment for using a hammer to break up the ice.

### Gardening Tool Attachments

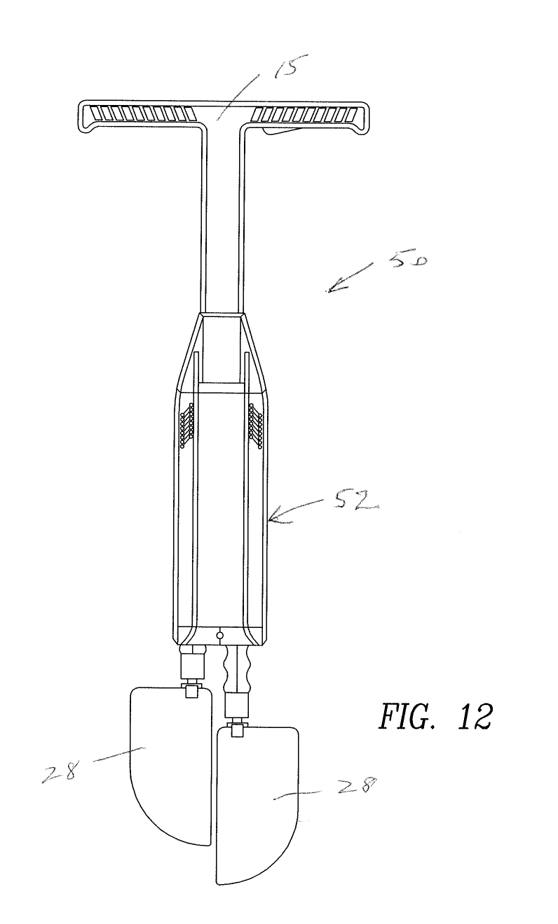

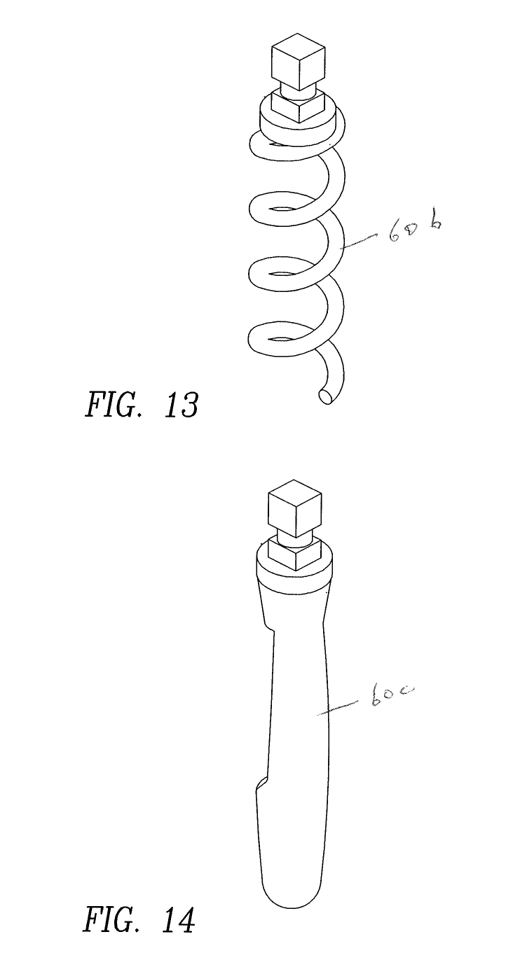

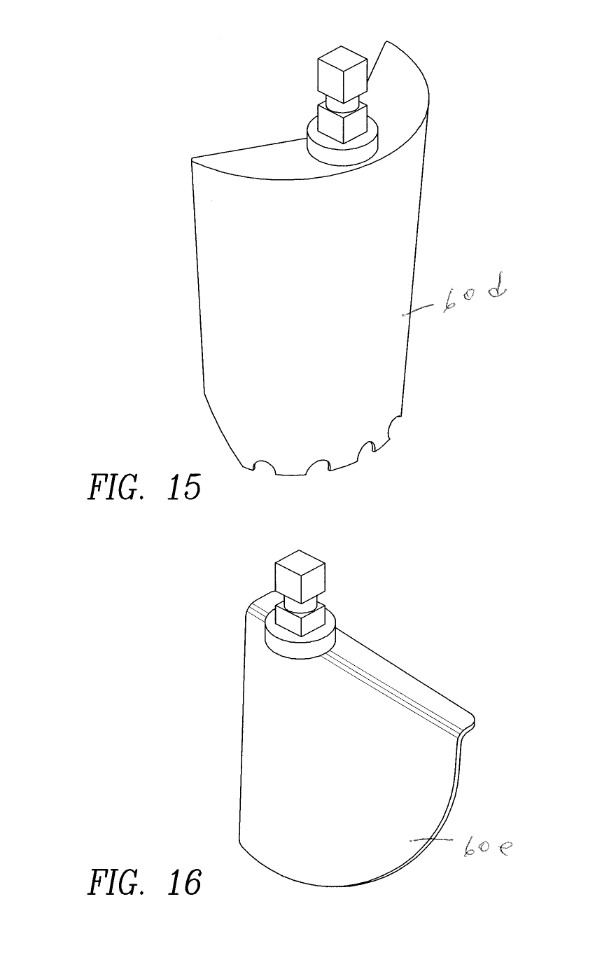

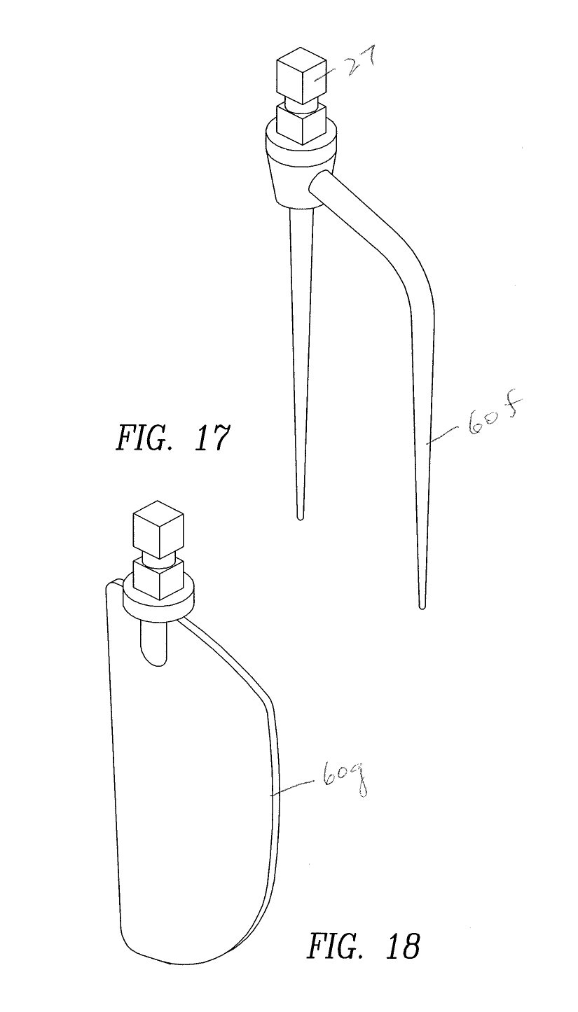

It should be understood that the present invention also maybe used as a gardening tool for chopping or breaking up soil, for planting, weeding, etc. For gardening functions, there are a variety of tool components allowing the gardening tool attachments 60 to perform a number of specialized tasks, including breaking up soil, removing weeds, aerating, planting bulbs, an edging attachment, a pitch tool, and a shovel attachment. These specific tools and attachments 60a to 60g are shown in FIGS. 12 to 18. More specifically, FIG. 12 shows the tool attachment for breaking up soil; FIG. 13 shows the tool attachment for removing weeds; FIG. 14 shows the tool attachment for aerating; FIG. 15 shows the tool attachment for planting bulbs; FIG. 16 shows the edging attachment; FIG. 17 shows the pitching attachment; and FIG. 18 shows the shovel attachment.

### Operation of the Present Invention

The portable ice chopper assembly 50 of the present invention has dual reciprocating blades 28 for chopping ice. The lightweight housing assembly 52 has an internal compartment 52a and ergonomic handles 1a, 2a are provided for controlling and operating the ice chopper assembly 50. The AC/DC rotating motor assembly 60 mounted in the internal compartment provides a cordless operation. The gear box assembly 54 is connected to the rotating motor assembly 60 for converting the rotating movement of the motor assembly 60 into reciprocating movement of the dual ice chopping blades 28. Dual reciprocating plungers 6 are connected to the gear box assembly 54 for driving the plungers in a reciprocating up and down linear movement, wherein the plungers 6 each have respective horizontal actuating bars 6a and 6b. The crank assembly 6 has eccentric bosses 5b and 5c mounted on both sides of the crank assembly 5 for engaging and actuating the horizontal bars 6a and 6b on the plungers 6, so that the dual plungers are moved in alternating up and down movements. The dual chuck assemblies 19, 20 are connected to the dual plungers 6 to drive the dual reciprocating ice cutting blades 28, so that the cutting blades move up and down in a linear reciprocating movement, with the two cutting blades 28 moving up and down in an alternating manner to chop the ice.

### Advantages of the Present Invention

The present invention has provided the advantage of an ice chopper having two reciprocating blades in order to provide more efficient ice chopping in an easy and fast manner.

The present invention has provided the advantage of a unique gear box assembly to provide quick and efficient reciprocating action for the dual-acting ice blades.

The present invention has provided the advantage of a portable ice chopper which has a battery pack and is cordless.

The present invention has provided the advantage of ergonomic handles on the ice chopper tool of the present invention so that it is easy to hold and control the reciprocating blade action, and a tool that is lightweight and easy to use.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1) A portable ice chopper assembly having dual reciprocating blades for chopping or breaking ice, comprising:
a) a lightweight housing assembly having an internal compartment and ergonomic handles for controlling and operating the ice chopper assembly;
b) a motor assembly mounted in said internal compartment having a rotating output shaft;
c) a gear box assembly connected to the rotating output shaft of said motor assembly for converting the rotating movement of said output shaft into reciprocating movement of the dual chopping blades;
d) dual reciprocating plungers connected to said gear box assembly for driving said plungers in a reciprocating up and down linear movement, said plungers each having respective horizontal actuating bars;
e) a crank assembly having eccentric bosses mounted on both sides of said crank assembly for engaging and driving said horizontal actuating bars on said dual plungers so that said plungers are moved in alternating up and down movements; and
f) dual chuck assemblies connected to said dual plungers to drive said dual reciprocating ice cutting blades, so that said chopping blades move up and down in a linear reciprocating movement, with said two chopping blades moving up and down in an alternating manner to chop the ice.

2) A portable ice chopper assembly in accordance with claim 1, further including a battery pack for providing a cordless operation.

3) A portable ice chopper assembly in accordance with claim 1, wherein said output shaft has a bevel gear drive for engaging and driving a pinion gear surrounding said crank assembly, and wherein said eccentric bosses are positioned 180 degrees apart.

4) A portable ice chopper assembly in accordance with claim 1, wherein said chuck assemblies are covered with protective boots.

5) A portable ice chopper assembly in accordance with claim 1, wherein said handles have mounted thereon an operating switch and a variable motor speed control unit.

6) A portable ice chopper assembly in accordance with claim 1, further including LED lights mounted on said housing for focusing light on said ice chopping blades.

7) A portable ice chopper assembly in accordance with claim 1, further including shock absorbers mounted on the ends of each said plunger shafts.

8) A portable gardening assembly having dual reciprocating chopping blades for chopping or breaking up soil, comprising:
a) a lightweight housing assembly having an internal compartment and ergonomic handles for controlling and operating the gardening assembly;
b) a motor assembly mounted in said internal compartment having a rotating output shaft;
c) a gear box assembly connected to the rotating output shaft of said motor assembly for converting the rotating movement of said output shaft into reciprocating movement of the dual chopping blades;
d) dual reciprocating plungers connected to said gear box assembly for driving said plungers in a reciprocating up and down linear movement, said plungers each having respective horizontal actuating bars;
e) a crank assembly having eccentric bosses mounted on both sides of said crank assembly for engaging and driving said horizontal actuating bars on said dual plungers so that said plungers are moved in alternating up and down movements; and
f) dual chuck assemblies connected to said dual plungers to drive said dual reciprocating gardening blades, so that said chopping blades move up and down in a linear reciprocating movement, with said two chopping blades moving up and down in an alternating manner to break up the soil.
